(19) United States
(12) Patent Application Publication
(10) Pub. No.: US 2017/0093957 A1
(43) Pub. Date: Mar. 30, 2017

(54) TRANSMISSION APPARATUS AND TRANSMISSION METHOD

(71) Applicant: FUJITSU LIMITED, Kawasaki-shi (JP)

(72) Inventors: Shigemori OOKAWA, Hakusan (JP); Masaki TAKEDA, Kahoku (JP); Takanori SASAKI, Takaoka (JP); Ken TAKASHIMA, Kanazawa (JP); Kunitake SUGIMOTO, Takaoka (JP)

(73) Assignee: FUJITSU LIMITED, Kawasaki-shi (JP)

(21) Appl. No.: 15/266,197

(22) Filed: Sep. 15, 2016

(30) Foreign Application Priority Data
Sep. 28, 2015 (JP) 2015-189464

(51) Int. Cl. H04L 29/08

(52) U.S. Cl. CPC H04L 67/06; H04L 67/327; H04L 67/42

(57) ABSTRACT

A transmission apparatus includes a plurality of ports configured to communicate with another transmission apparatus, a storage configured to store a data file, attribute information of the data file, and management information indicating to respond or not to a transfer request for the data file with respect to each of the plurality of ports, respectively, and a processor configured to transmit the attribute information from each of the plurality of ports, and decide whether or not to transmit the data file from a first port of the plurality of ports on the basis of the management information when the first port receives the transfer request from the other transmission apparatus.

### CROSS-REFERENCE TO RELATED APPLICATION

This application is based upon and claims the benefit of priority of the prior Japanese Patent Application No. 2015-189464, filed on Sep. 28, 2015, the entire contents of which are incorporated herein by reference.

### FIELD

The present embodiment disclosed herein relates to a transmission apparatus and a transmission method.

### BACKGROUND

Software or a field-programmable gate array (FPGA) for a node (e.g. transmission apparatus) belonging to a network operated by a communication carrier is frequently updated (for example, version upgrade) by a manual operation of a network manager in the present state. In the updating operation, a terminal operated by the network manager accesses each node and causes the node to execute updating on the basis of a down load (DL) file for updating.

However, in recent years, as the multi-functioning of nodes proceeds, the size of DL files increases larger and larger. Therefore, the time taken for an updating work by the network manager is increasing. In other words, the operating expense (OPEX) taken for an updating work of a node is increasing.

Here, if it is tried to cause a node to be updated not by a manual operation of the network manager but automatically, then such updating is performed endlessly unless a scheme for suppressing a node, which is not desirable to be updated, from being updated is applied. FIG. 1 is a view illustrating updating of nodes belonging to networks. For example, it is assumed that such a network is that is an own company network, a network 2c that is another own company network but located in a different district with the network is and a network 3c that is a different company network as depicted in FIG. 1 are available. In such a network configuration as just described, if it is desired to update only nodes belonging, for example, to the network 1c, then it may be unacceptable to update also nodes in the network 2c and nodes in the network 3c.

In regard to such a problem as described above, certain documents, namely Japanese Laid-open Patent Publication No. 2007-221234 and Japanese Laid-open Patent Publication No. 2009-93637 disclose a technology of automatically notifying only a specific terminal apparatus among terminal apparatus coupled to a network of updating information of a web page. However, since this technology is not directed to updating of software or the like of terminal apparatus, the technology is not useful to automatic updating of software or the like of a node.

### SUMMARY

According to an aspect of the embodiment, a transmission apparatus includes a plurality of ports configured to communicate with another transmission apparatus, a storage configured to store a data file, attribute information of the data file, and management information indicating to respond or not to a transfer request for the data file with respect to each of the plurality of ports, respectively, and a processor configured to transmit the attribute information from each of the plurality of ports, and decide whether or not to transmit the data file from a first port of the plurality of ports on the basis of the management information when the first port receives the transfer request from the other transmission apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating updating of nodes belonging to networks;

FIG. 2 is a view illustrating an edge node and a relay node;

FIG. 3 is a view illustrating setting of a port to an edge node;

FIG. 4 is a view illustrating an outline of a network configuration in an embodiment;

FIG. 5 is a block diagram of a node;

FIG. 6 is a block diagram of a monitoring controlling apparatus;

FIG. 7 is a view illustrating an example of a piling table;

FIG. 8 is a view illustrating an example of data stored in a version data storage unit;

FIG. 9 is a view illustrating an example of a transmission frame table;

FIG. 10 is a view illustrating an example of a reception frame table;

FIG. 11 is a view illustrating an example of a continuity check message (CCM) frame in the present embodiment;

FIGS. 12 to 14 are flow charts depicting processing flows of processing executed by a node;

FIGS. 15 to 22 are views particularly illustrating operations of a node;

FIG. 23 is a flow chart depicting processing by a node for notifying a monitoring controlling apparatus of completion of updating;

FIG. 24 is a view illustrating a process by a relay node for deciding coincidence of versions;

FIG. 25 is a view illustrating a process by an edge node for deciding coincidence of versions;

FIG. 26 is a view illustrating a reason why completion of updating can be decided from a completion notification from an edge node;

FIGS. 27 and 28 are flow charts illustrating processing executed by a monitoring controlling apparatus;

FIG. 29 is a view depicting an example of a display screen image;

FIG. 30 is a functional block diagram of a node; and

FIG. 31 is a functional block diagram of a computer.

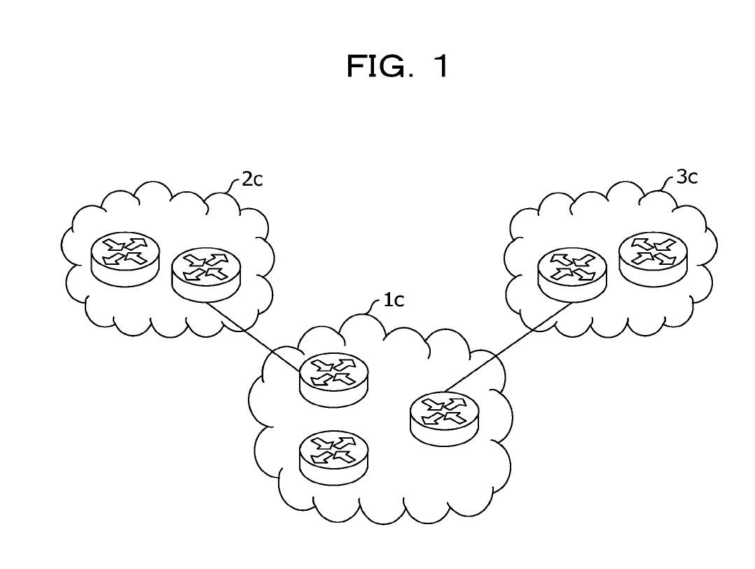

### DESCRIPTION OF EMBODIMENT

In one aspect, it is an object of the present embodiment to provide a technology for limiting nodes in which updating of software or the like is to be performed.

### Outline of Present Embodiment

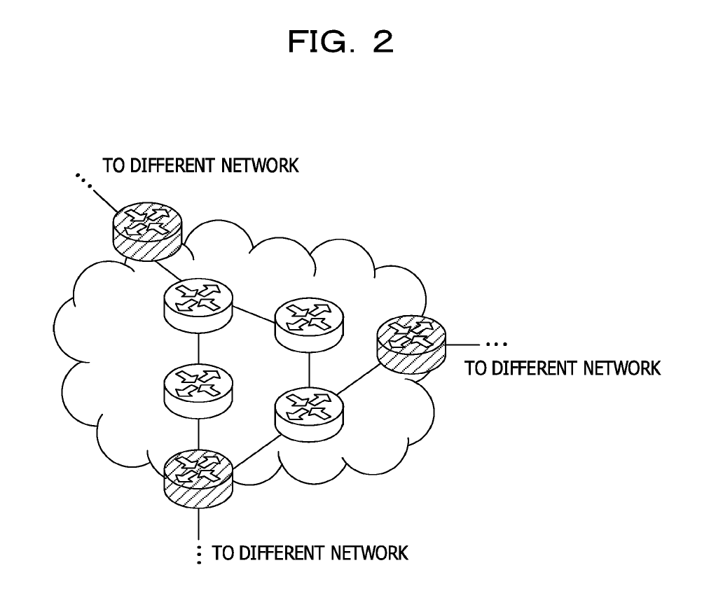

FIG. 2 is a view illustrating an edge node and a relay node. For example, it is assumed that seven nodes depicted in FIG. 2 are to be updated. The seven nodes belong to the same network, and nodes indicated by slanting lines include a port coupling to a node belonging to a different network. In the following description, each of such nodes as just described is referred to as edge node. The other nodes that are not indicated by slanting lines do not include a port coupling to a node belonging to a different network. In the following description, each of such nodes is referred to as relay node. Each solid line between nodes represents a circuit.

In the present embodiment, data used for updating (hereinafter referred to as DL file) is transferred from a node to another node, and each node executes updating using a DL file. Accordingly, in order to suppress any node belonging to a different network from being updated, a countermeasure may be taken not to transfer a DL file from an edge node to a node belonging to a different network. In the present embodiment, a countermeasure is taken for suppressing a DL file from being transmitted from a port coupling to a node belonging to a different network such that a DL file is transferred only between nodes belonging to a target network.

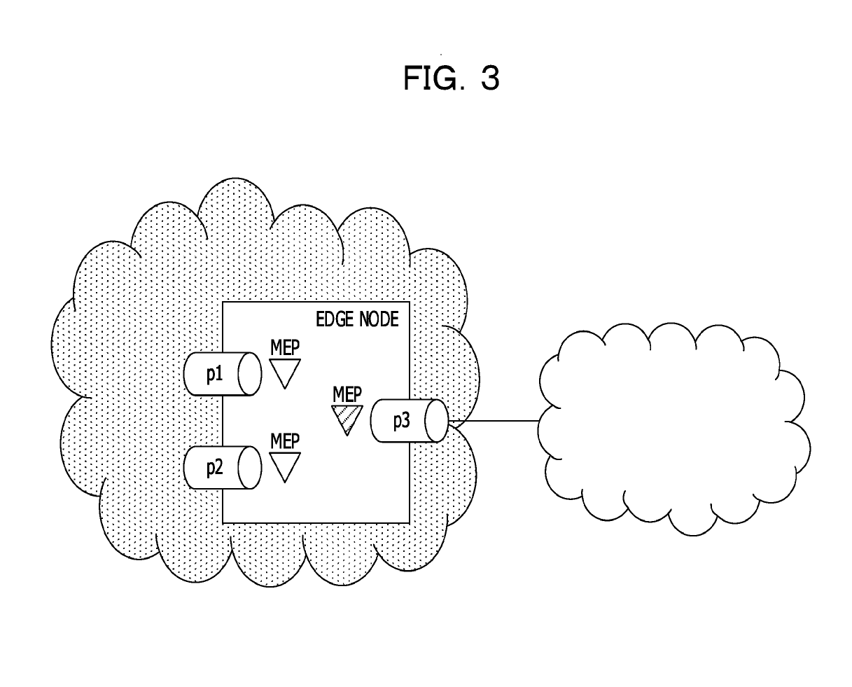

With reference to FIG. 3, setting of a port of an edge node is described briefly. In FIG. 3, a network of a target of updating is shadowed, and an edge node belonging to the network of the updating target includes ports p1 to p3. Each of the ports p1 to p3 corresponds to a maintenance end point (MEP) in operations, administration, maintenance (Ethernet OAM) (Ethernet is a registered trademark). To the port p3 coupling to a different network, file non-transfer setting (hereinafter referred to as “Piling setting”) for suppressing transfer of a DL file is applied. An inverted triangular mark having slanting lines applied thereto represents that the Piling setting is applied to the port while an inverted triangular mark having no slanting lines applied thereto represents that the Piling setting is not applied to the port. This similarly applies also to the other like figures. By utilizing such Piling setting, nodes in which updating of software or the like is to be performed can be limited.

### Particular Mode of Present Embodiment

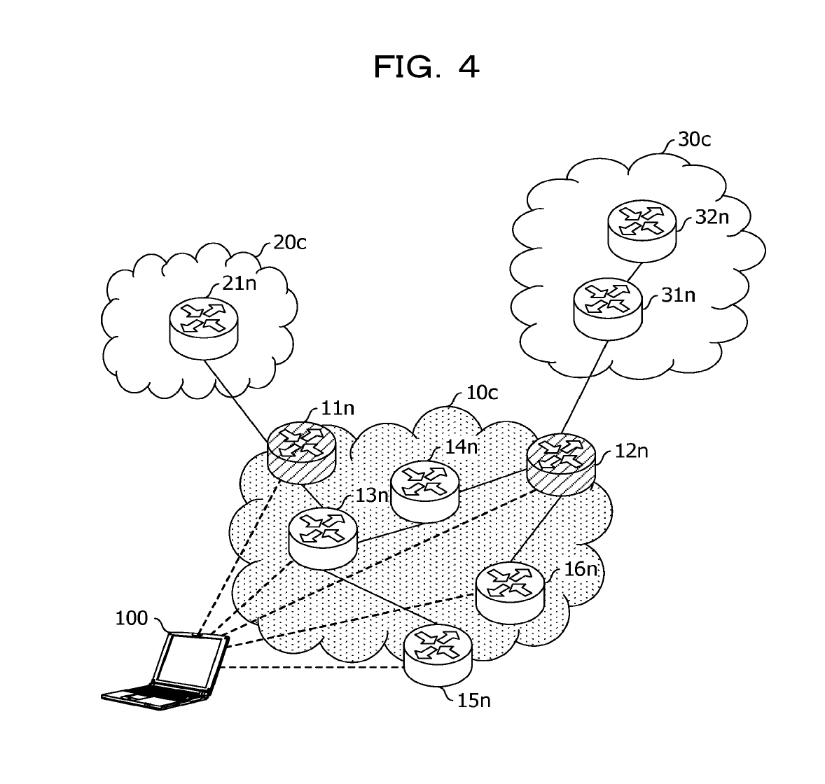

FIG. 4 depicts an outline of a network configuration in the present embodiment. To each of networks 10c to 30c that are, for example, networks of carriers, one or a plurality of nodes (for example, transmission apparatus) belong. In particular, nodes 11n to 16n belong to the network 10c; a node 21n belongs to the network 20c; and nodes 31n and 32n belong to the network 30c. In the present embodiment, the network 10c is determined as an updating target, and the nodes 11n and 12n are edge nodes while nodes 13n to 16n are relay nodes. Solid lines between the nodes represent user circuits.

A monitoring controlling apparatus 100 that is, for example, a personal computer or a server is coupled to the nodes belonging to the network 10c through control circuits indicated by broken lines. Although a broken line between the monitoring controlling apparatus 100 and the node 14n is not depicted in order to facilitate recognition of the figure, the node 14n is also coupled to the monitoring controlling apparatus 100 through a control circuit.

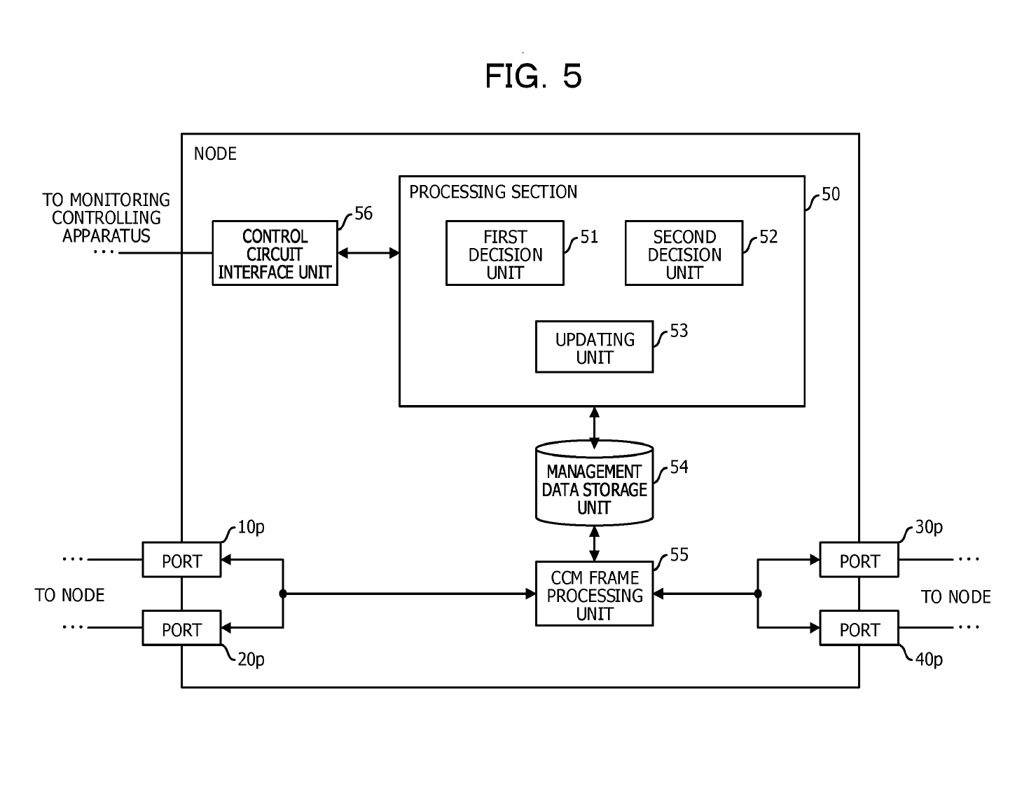

FIG. 5 depicts a block diagram of a node. The node includes a processing section 50, a management data storage unit 54, a CCM frame processing unit 55, a control circuit interface unit 56, and ports 10p to 40p. The processing section 50 includes a first decision unit 51, a second decision unit 52, and an updating unit 53. The management data storage unit 54 is provided, for example, in a memory of the node. The processing section 50 is implemented, for example, by a central processing unit (CPU) of the node executing a program for executing a process of the present embodiment. It is to be noted that, although the number of ports in the example of FIG. 5 is four, there is no limitation to the number of ports.

The first decision unit 51 executes a process on the basis of data stored in the management data storage unit 54. On the basis of a result of the process, the first decision unit 51 updates the data stored in the management data storage unit 54. The second decision unit 52 executes a process on the basis of data stored in the management data storage unit 54 and outputs, when a result of the process satisfies a given condition, a completion notification to the control circuit interface unit 56. The updating unit 53 executes a process for updating software (firmware, a driver, a boot file and so forth) or an FPGA of the node on the basis of the DL file stored in the management data storage unit 54. The control circuit interface unit 56 executes a process for performing communication with the monitoring controlling apparatus 100 through a control circuit and transmits, when a completion notification is received from the second decision unit 52, a completion notification to the monitoring controlling apparatus 100. The CCM frame processing unit 55 executes a process for updating data stored in the management data storage unit 54 on the basis of a CCM frame received from any of the ports 10p to 40p. Further, the CCM frame processing unit 55 generates a CCM frame on the basis of data stored in the management data storage unit 54 and transmits the CCM frame from one of the ports 10p to 40p. The CCM frame is a frame used in the Ethernet OAM for implementing periodic communication confirmation.

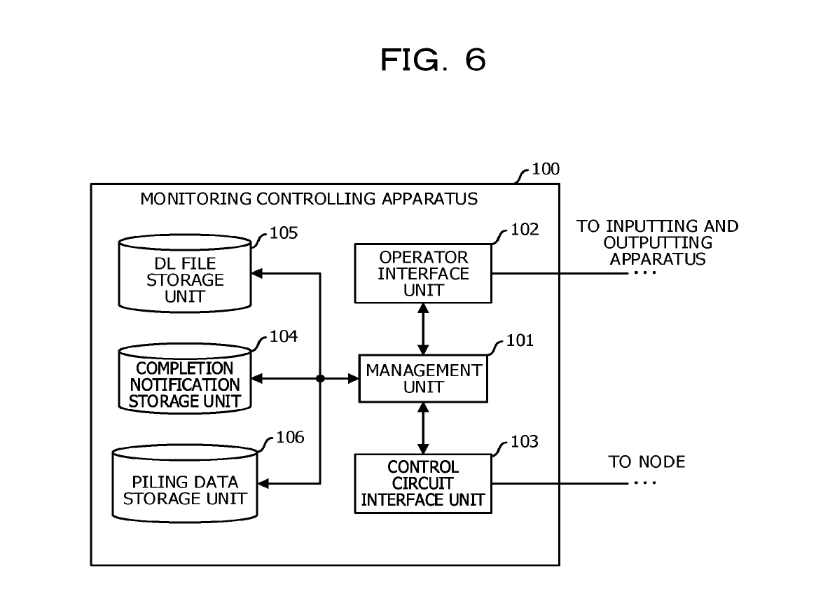

FIG. 6 depicts a block diagram of a monitoring controlling apparatus. Note that, the monitoring controlling apparatus described with reference to FIG. 6 may be the monitoring controlling apparatus 100 depicted in FIG. 4. The monitoring controlling apparatus 100 includes a management unit 101, an operator interface unit 102, a control circuit interface unit 103, a completion notification storage unit 104, a DL file storage unit 105 and a piling data storage unit 106. The completion notification storage unit 104, DL file storage unit 105 and piling data storage unit 106 are provided, for example, in a memory of the monitoring controlling apparatus 100. The management unit 101 is implemented, for example, by the CPU of the monitoring controlling apparatus 100 executing a program for implementing a process of the present embodiment. It is to be noted that, although also the monitoring controlling apparatus 100 includes ports, since the ports are not associated with principal processes in the present embodiment, description of them is omitted herein.

The management unit 101 stores, when a completion notification is received through the control circuit interface unit 103, the received completion notification into the completion notification storage unit 104. Further, the management unit 101 starts updating of the nodes in the network 10c on the basis of the DL file stored in the DL file storage unit 105 in response to an instruction accepted through the operator interface unit 102. The operator interface unit 102 executes a process for transferring data between inputting and outputting apparatus (for example, a keyboard and a display unit) of the monitoring controlling apparatus 100 and the management unit 101 and some other processes. The control circuit interface unit 103 executes a process for communicating with the nodes in the network 10c through the control circuits. The piling data storage unit 106 stores therein information representative of to which port in the network 10c the Piling setting is applied.

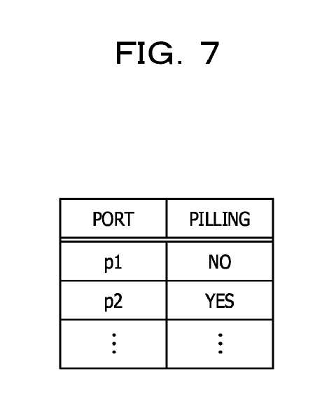

FIG. 7 illustrates an example of a piling table stored in a management data storage unit. The management data storage unit described with reference to FIG. 7 may be the management data storage unit 54 depicted in FIG. 5. In the example of FIG. 7, information indicative of whether or not the Piling setting is applied is stored for each port. Although the DL file is not transmitted from the port to which the Piling setting is applied, transmission and reception of a CCM frame are performed by the port. The network manager will determine in advance a range within which updating is to be executed and set the piling tables of the nodes and data in the piling data storage unit 106 of the monitoring controlling apparatus 100. Alternatively, the network manager will set data in the piling data storage unit 106 of the monitoring controlling apparatus 100 in advance, and the monitoring controlling apparatus 100 transmits the data to the nodes such that the nodes set the respective piling tables.

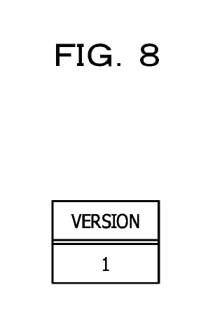

FIG. 8 illustrates an example of data stored in a version data storage unit in a management data storage unit. The management data storage unit described with reference to FIG. 8 may be the management data storage unit 54 depicted in FIG. 5. In the example of FIG. 8, information representative of the version of the software or the FPGA of the own node is stored.

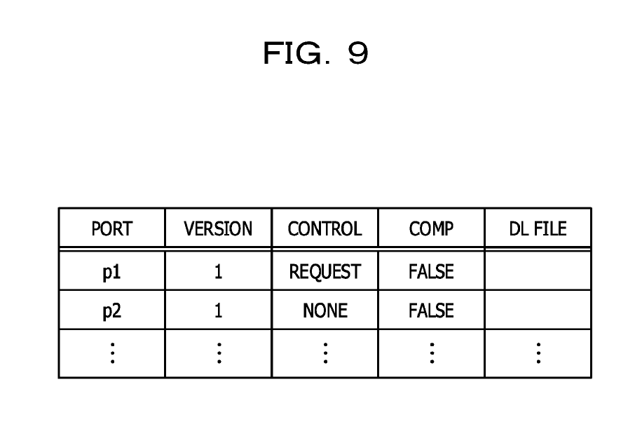

FIG. 9 illustrates an example of a transmission frame table stored in a management data storage unit. The management data storage unit described with reference to FIG. 9 may be the management data storage unit 54 depicted in FIG. 5. In the example of FIG. 9, an identifier of a port from which a CCM frame is to be transmitted, a value of a Version field of a CCM frame to be transmitted, a value of a Control field of a CCM frame to be transmitted, a value of a Comp field of a CCM frame to be transmitted, and a DL file where the DL file is to be transmitted are stored.

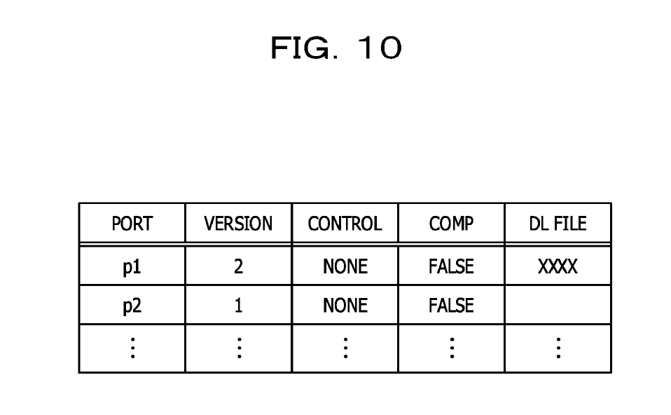

FIG. 10 illustrates an example of a reception frame table stored in a management data storage unit. The management data storage unit described with reference to FIG. 10 may be the management data storage unit 54 depicted in FIG. 5. In the example of FIG. 10, an identifier of a port at which a CCM frame is to be received, a value of a Version field of the received CCM frame, a value of a Control field of the received CCM frame, a value of a Comp field of the received CCM frame and a DL file when the DL file is received are stored.

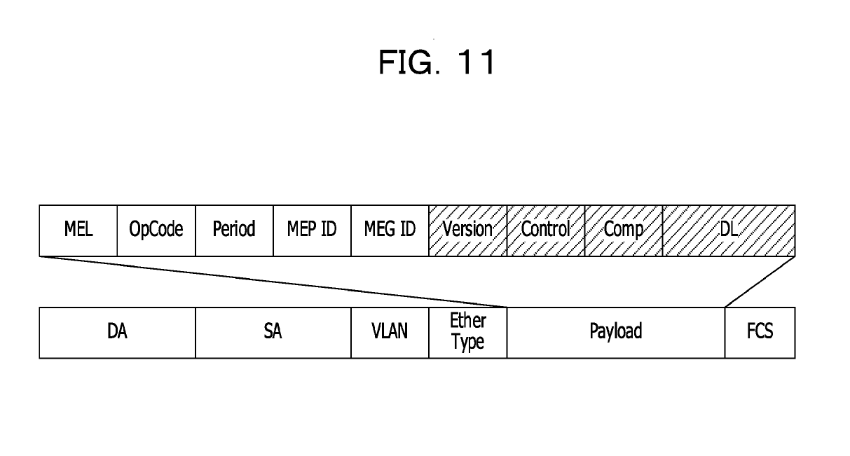

FIG. 11 depicts an example of a CCM frame in the present embodiment. In the present embodiment, to a free space of an ordinary CCM frame in the Ethernet OAM, a Version field, a Control field, a Comp field and a DL field are added. In the Version field, a version number of the software or the FPGA is included. The Control field is set to “None,”“Request,”“Reject,” “Sending” or “Complete.” “None” is a value to be set when the version is in a normal state. “Request” is a value set where a request for a DL file is to be issued to an opposing node. “Reject” is a value set when a request for a DL file from an opposing node is to be rejected. “Sending” is a value set when a DL field is being transmitted to an opposing node. “Complete” is a value set when transmission of a DL file to an opposing node is completed. The Comp field is set to “True” or “False.” “True” is a value set when the version of a port other than the port to which the Piling setting is applied coincides with the version of an opposing node. “False” is a value set when “True” is not set. The DL field includes a DL file (sometimes includes only part of a DL file). The other fields are same as those of an ordinary CCM frame, and therefore, detailed description of the other fields is omitted herein. In the present embodiment, the opposing node is a node of a coupling destination of the port (for example, a neighboring node).

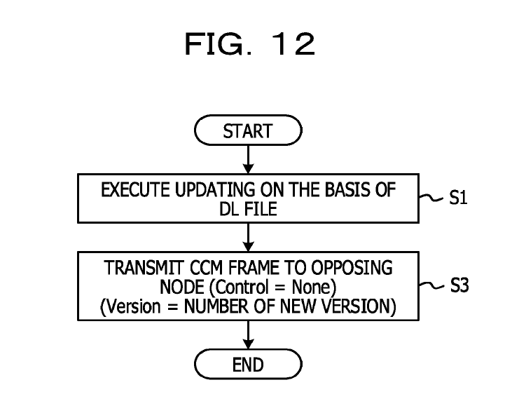

Now, a process executed by a node upon starting of updating is described with reference to FIG. 12.

In the present embodiment, updating is started on one node, and the updating is propagated to the nodes in the network 10c. For example, if a DL file of software or the FPGA is stored newly into the DL file storage unit 105 of the monitoring controlling apparatus 100, then the network manager who operates the monitoring controlling apparatus 100 would input a transmission instruction of the DL file stored in the DL file storage unit 105. In response to the input, the monitoring controlling apparatus 100 reads out the DL file stored in the DL file storage unit 105 and transmits the DL file to one of the nodes in the network 10c (here, it is assumed that the network of the updating target is the network 10c) through the control circuit interface unit 103. The node of the transmission destination may be designated in a transmission instruction by the network manager or may be a node determined in advance. It is to be noted that, although not a single node but a plurality of nodes may be determined as transmission destinations, if updating is started in at least one of the nodes, then updating is performed in all nodes in the network 10c.

Each node of the transmission destination of the DL file receives the DL file through the control circuit interface unit 56 and stores the DL file into the management data storage unit 54. Then, the updating unit 53 in the node executes updating on the basis of the DL file stored in the management data storage unit 54 (FIG. 12: S1). The updating is, for example, version upgrade or version downgrade of the software or the FPGA, and in the following, the updating is described taking version upgrade as an example.

The updating unit 53 updates the transmission frame table in the management data storage unit 54. In particular, the updating unit 53 sets the value of the Control field for each of the ports 10p to 40p to “None” and changes the value of the Version field to the number of the new version.

Then, the CCM frame processing unit 55 transmits a CCM frame in which the value of the Control field is “None” and the value of the Version field is the number of the new version to an opposing node (S3). Then, the processing is ended. However, the exchange of the CCM frame is performed continuously.

With such a countermeasure as described above, the monitoring controlling apparatus 100 may not access the nodes in the network 10c, and therefore, it becomes possible to reduce the OPEX for use in an updating operation of the nodes.

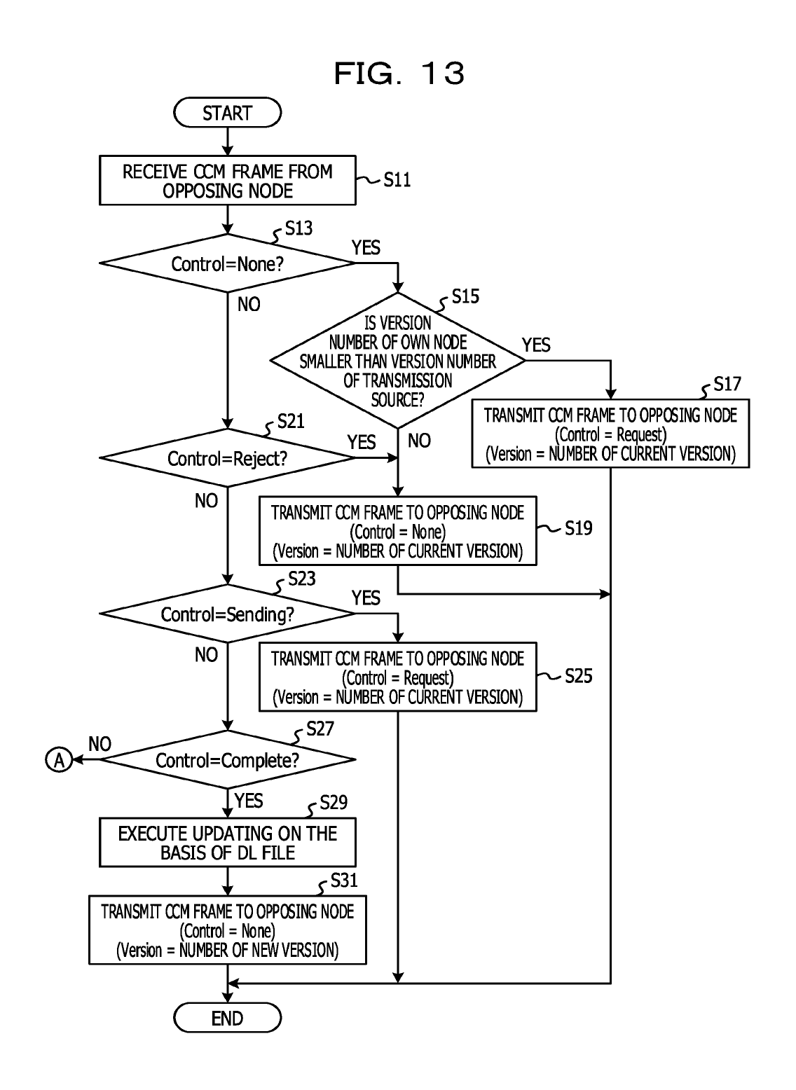

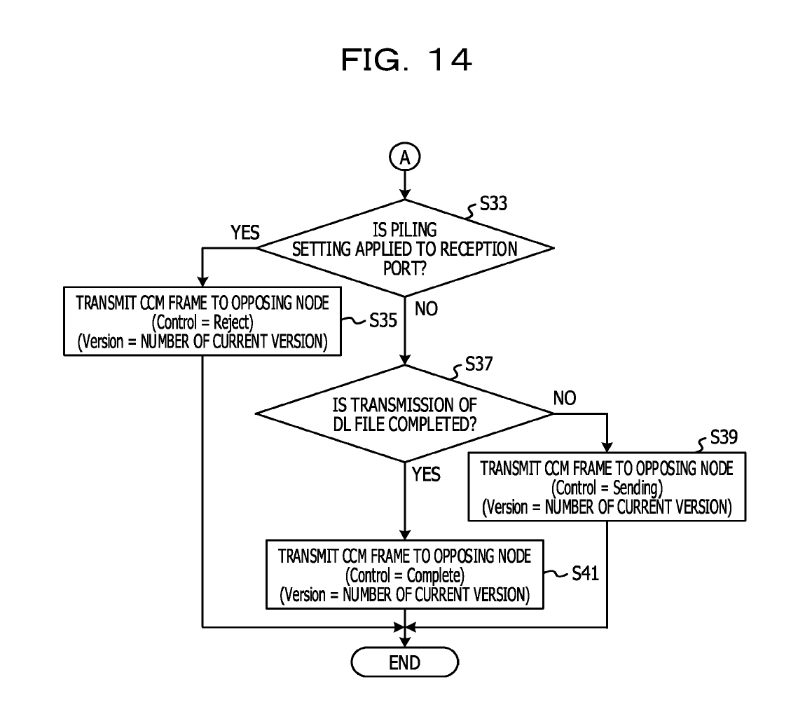

Now, a process executed by a node receiving a CCM frame is described with reference to FIGS. 13 and 14.

First, the CCM frame processing unit 55 in the node receives a CCM frame from an opposing node through one of the ports 10p to 40p (FIG. 13: S11). In the following, the port at which the CCM frame is received at step S11 is referred to as reception port.

The CCM frame processing unit 55 updates the reception frame table on the basis of the received CCM frame. In particular, the CCM frame processing unit 55 sets, with regard to the reception port, the value of the Version field and the value of the Control field to values included in the received CCM frame. Further, if a DL file is included in the received CCM frame, then the CCM frame processing unit 55 stores the DL file. It is to be noted that the DL file may not be an entire DL file but may be part of a DL file.

The first decision unit 51 decides whether or not the value of the Control field of the CCM frame (namely, the value of the Control field stored in the reception frame table and corresponding to the identifier of the reception port of the CCM frame) is “None” (S13).

If the value of the Control field of the CCM frame is “None” (S13: Yes), then the first decision unit 51 decides whether or not the version number of the own node is smaller than the value of the Version field of the CCM frame (namely, the value of the Version field stored in the reception frame table and corresponding to the identifier of the reception port of the CCM frame) (S15). The value of the Version field of the CCM frame represents the version number of the opposing node.

If the version number of the own node is smaller than the value of the Version field of the CCM frame (S15: Yes), then the first decision unit 51 updates the transmission frame table. In particular, the first decision unit 51 sets, with regard to the reception port of the CCM frame, the value of the Control field to “Request” and sets the value of the Version field to the number of the current version.

In response to the settings, the CCM frame processing unit 55 generates a CCM frame in which the value of the Control field is “Request” and the value of the Version field is the number of the current version and transmits the CCM frame from the reception port (S17). Then, the processing is ended.

On the other hand, if the version number of the own node is not smaller than the value of the Version field of the CCM frame (S15: No), then the first decision unit 51 updates the transmission frame table. In particular, the first decision unit 51 sets the value of the Control field to “None” and sets the value of the Version field to the number of the current version with regard to the reception port of the CCM frame.

In response to the settings, the CCM frame processing unit 55 generates a CCM frame in which the value of the Control field is “None” and the value of the Version field is the number of the current version and transmits the generated CCM frame from the reception port (S19). Then, the processing is ended.

On the other hand, if the value of the Control field of the CCM frame is not “None” (S13: No), then the first decision unit 51 decides whether or not the value of the Control field of the CCM frame is “Reject” (S21). If the value of the Control field of the CCM frame is “Reject” (S21: Yes), then the processing advances to step S19.

If the value of the Control field of the CCM frame is not “Reject” (S21: No), then the first decision unit 51 decides whether or not the value of the Control field of the CCM frame is “Sending” (S23).

If the value of the Control field of the CCM frame is “Sending” (S23: Yes), then the first decision unit 51 updates the transmission frame table. In particular, the first decision unit 51 sets the value of the Control field to “Request” and sets the value of the Version field to the number of the current version with regard to the reception port of the CCM frame. It is to be noted that the first decision unit 51 stores the DL file included in the received CCM frame into the management data storage unit 54.

In response to the settings, the CCM frame processing unit 55 generates a CCM frame in which the value of the Control field is “Request” and the value of the Version field is the number of the current version and transmits the generated CCM frame from the reception port (S25). Then, the processing is ended.

On the other hand, if the value of the Control field of the CCM frame is not “Sending” (S23: No), then the first decision unit 51 decides whether or not the value of the Control field of the CCM frame is “Complete” (S27).

If the value of the Control field of the CCM frame is “Complete” (S27: Yes), then the updating unit 53 updates the software or the FPGA on the basis of the DL file stored in the DL file storage unit 105 (S29). Then, the updating unit 53 updates the transmission frame table. In particular, the updating unit 53 sets the value of the Control field to “None” and sets the value of the Version field to the number of the new version with regard to the reception port of the CCM frame.

In response to the settings, the CCM frame processing unit 55 generates a CCM frame in which the value of the Control field is “None” and the value of the Version field is the number of the current version and transmits the generated CCM frame from the reception port (S31). Then, the processing is ended.

On the other hand, if the value of the Control field of the CCM frame is not “Complete” (S27: No), then the value of the Control field of the CCM frame is “Request.” Therefore, the processing advances to step S33 of FIG. 14 through a terminal A.

Referring now to FIG. 14, the first decision unit 51 decides whether or not the Piling setting is applied to the reception port (in other words, the piling table has stored therein information representing that the Piling setting is applied in association with the identifier of the reception port) (S33).

If the Piling setting is applied to the reception port (S33: Yes), then the first decision unit 51 updates the transmission frame table. In particular, the first decision unit 51 sets the value of the Control field to “Reject” and sets the value of the Version field to the number of the current version with regard to the reception port of the CCM frame.

In response to the settings, the CCM frame processing unit 55 generates a CCM frame in which the value of the Control field is “Reject” and the value of the Version field is the number of the current version and transmits the generated CCM frame from the reception port (S35). Then, the processing is ended.

On the other hand, if the Piling setting is not applied to the reception port (S33: No), then the first decision unit 51 decides whether or not transmission of the DL file is completed (S37). The DL file may not be transmitted with one CCM frame depending upon the size thereof, and in this case, the DL file is divided. At step S37, it is decided whether or not part of the DL file remains without being transmitted.

If the transmission of the DL file is not completed (S37: No), then the first decision unit 51 updates the transmission frame table. In particular, the first decision unit 51 sets the value of the Control field to “Sending” and sets the value of the Version field to the number of the current version with regard to the reception port of the CCM frame and then stores part of the DL file into the DL field.

In response to the settings, the CCM frame processing unit 55 generates a CCM frame in which the value of the Control field is “Sending” and the value of the Version field is the number of the current version and which includes part of the DL file and transmits the generated CCM frame from the reception port (S39). Then, the processing is ended.

On the other hand, if the transmission of the DL file is completed (S37: Yes), then the first decision unit 51 updates the transmission frame table. In particular, the first decision unit 51 sets the value of the Control field to “Complete” and sets the value of the Version field to the number of the current version with regard to the reception port of the CCM frame.

In response to the settings, the CCM frame processing unit 55 generates a CCM frame in which the value of the Control field is “Complete” and the value of the Version field is the number of the current version and transmits the generated CCM frame from the reception port (S41). Then, the processing is ended.

With the countermeasure described above, each node receiving the DL file can automatically execute updating. Further, even if a CCM frame in which the value of the Control field is “Request” is received from a node belonging to a network other than the network 10c, if the Piling setting is applied to the reception port, then the DL file is not transmitted. Consequently, it is possible to limit the nodes in which updating is to be performed to the nodes in the network 10c.

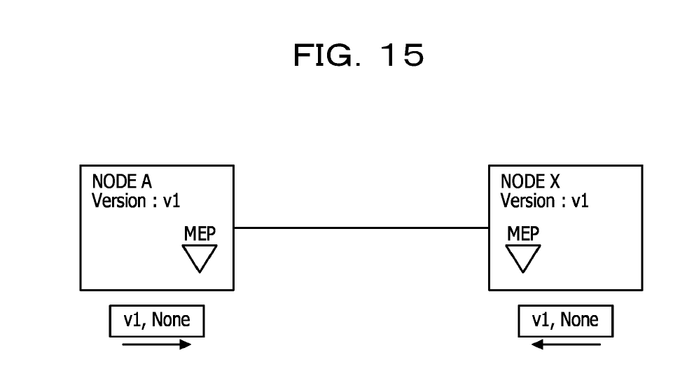

Here, operation of a node in the present embodiment is described particularly with reference to FIGS. 15 to 22. First, it is assumed that, in the example of FIGS. 15 to 20, a port of a certain node A to which the Piling setting is not applied and a port of another node X as an opposing node to which the Piling setting is not applied are coupled to each other by a user circuit. Further, it is assumed that both of the nodes A and X are nodes for which version upgrade is to be performed.

If the version of the node A and the version of the node X are same as each other as seen in FIG. 15, then no updating may be performed (namely, both nodes A and X are in a steady state), and the values of the Control field of the CCM frames remain “None.”

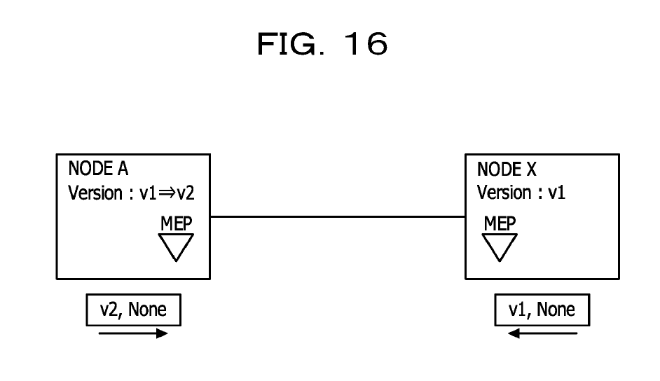

Here, if the version of the node A is changed from “v1” to “v2” by the DL file from the monitoring controlling apparatus 100 as depicted in FIG. 16, then a CCM frame in which the value of the Version field is “2” is transmitted from the node A to the node X.

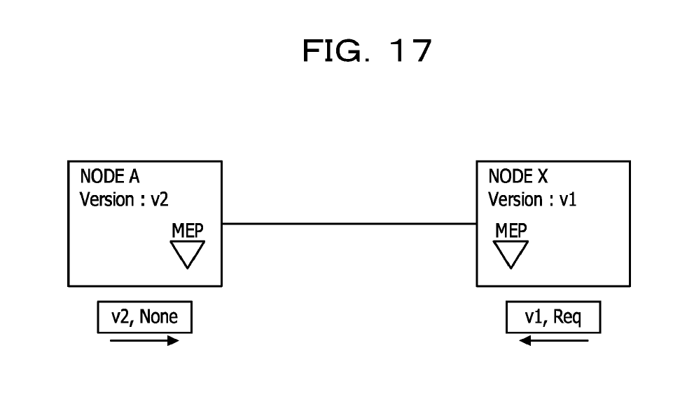

As depicted in FIG. 17, the value of the Version field of a CCM frame transmitted from the node X is “1” and is lower than the value “2” of the Version field of the CCM frame transmitted from the node A. Accordingly, the node X transmits a CCM frame in which the value of the Control field is “Request” to the node A.

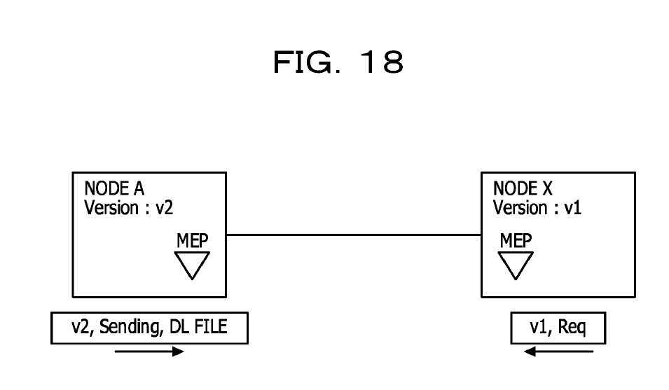

When the node A receives the CCM frame in which the value of the Control field is “Request” from the node X as depicted in FIG. 18, then the node A transmits, to the node X, a CCM frame in which the value of the Control field is “Sending” and which includes at least part of the DL file of the version “v2.” If it is difficult to transmit the DL file by a single CCM frame, then the DL file is divided.

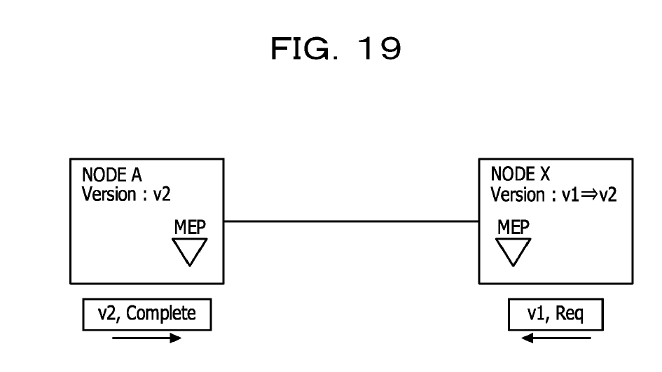

If the node A completes the transmission of the DL file as depicted in FIG. 19, then the node A transmits a CCM frame in which the value of the Control field is “Complete” to the node X. On the other hand, the node X performs version upgrade from the version “v1” to the version “v2” on the basis of the DL file received from the node A.

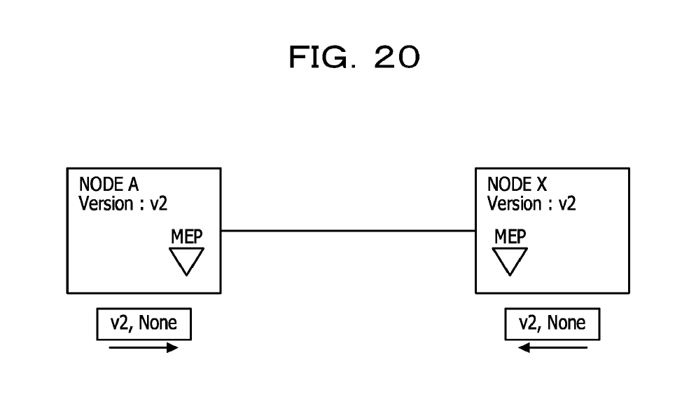

If the version upgrade of the node X is completed as depicted in FIG. 20, then the node X transmits a CCM frame in which the value of the Version field is “2” and the value of the Control field is “None” to the node A. On the other hand, when the CCM frame is received from the node X, the node A transmits a CCM frame in which the value of the Control field is “None” to the node X. Consequently, the versions of both nodes become version “v2,” and a steady state is established.

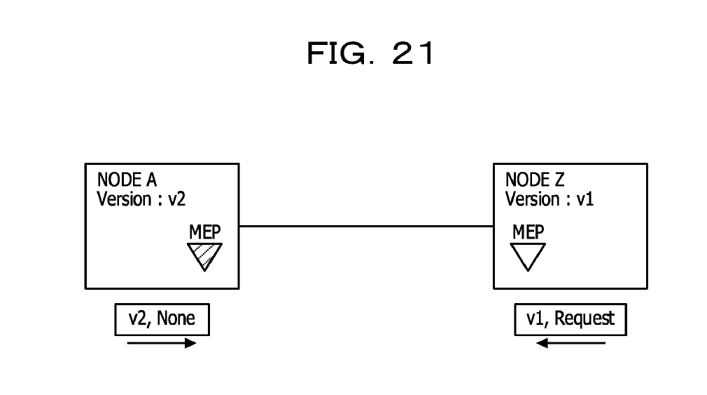

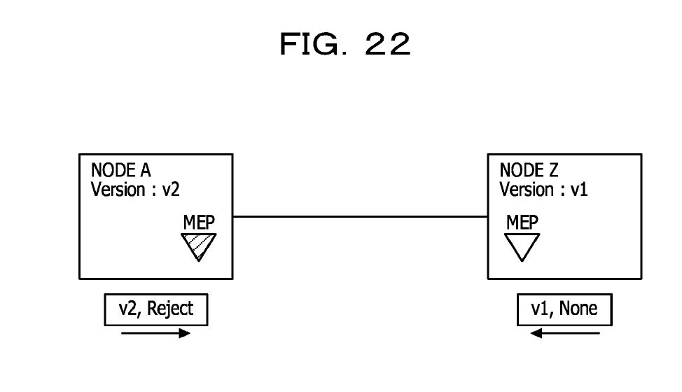

On the other hand, in the examples of FIGS. 21 and 22, a port of a certain node A to which the Piling setting is applied and another port of a node Z as an opposing node to which the Piling setting is not applied are coupled to each other by a user circuit. It is assumed that, although the node A is a node for which version upgrade is to be performed, the node Z is a node for which version upgrade is not to be performed.

As depicted in FIG. 21, the value of the Version field of a CCM frame transmitted from the node Z is “1” and is lower than the value “2” of the Version field of a CCM frame transmitted from the node A. Accordingly, the node Z transmits a CCM frame in which the value of the Control field is “Request” to the node A.

Although the node A receives a CCM frame in which the value of the Control field is “Request” from the node Z, the Piling setting is applied to the reception port of the node A. Accordingly, as depicted in FIG. 22, the node A transmits a CCM frame in which the value of the Control field is “Reject” to the node Z. On the other hand, if the node Z receives a CCM frame in which the value of the Control field is “Reject” from the node A, the node Z transmits a CCM frame in which the value of the Control field is “None” to the node A. By such operations, version upgrade can be suppressed from being performed in the node Z.

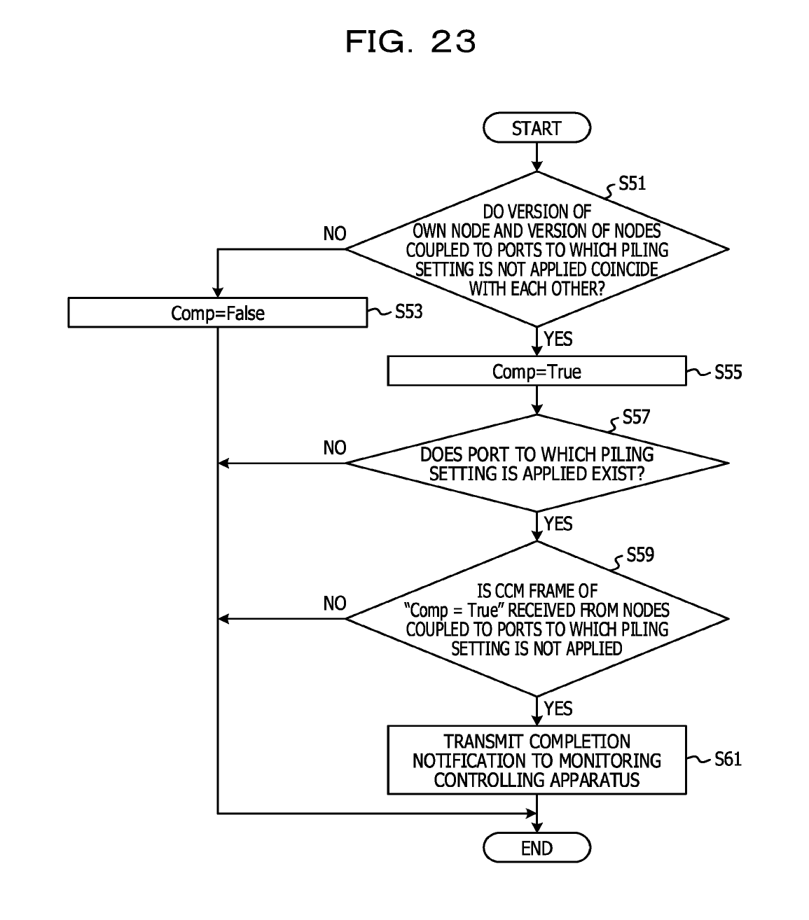

Now, a process of a node for notifying a monitoring controlling apparatus of completion of updating is described with reference to FIG. 23. The monitoring controlling apparatus described with reference to FIG. 23 may be the monitoring controlling apparatus 100 depicted in FIG. 4. The present process is executed, for example, after every fixed interval of time.

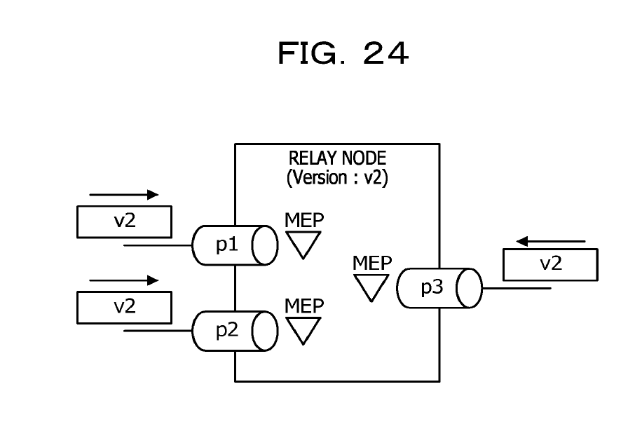

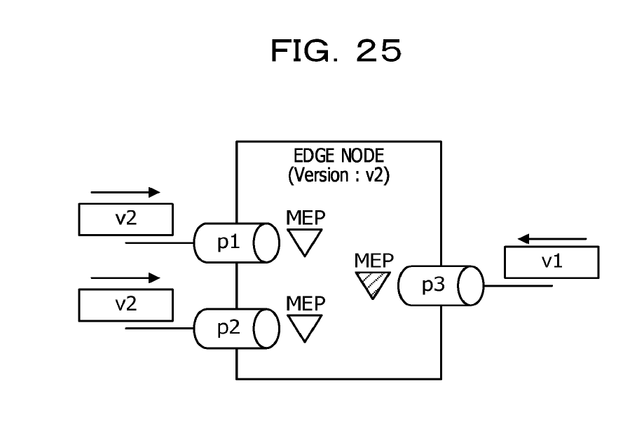

First, the second decision unit 52 in the node compares the version information stored in the version data storage unit and the value of the Version field stored in the reception frame table with each other to decide whether or not the version of the own node and the version of nodes coupled to ports to which the Piling setting is not applied coincide with each other (FIG. 23: S51). It is to be noted that, in regard to a relay node, it is decided whether or not the version of the own node and the version of each node coincide with each other, for example, as depicted in FIG. 24. In contrast, in regard to an edge node, it is decided whether or not the version of the own node and the version of each node coupled to a port to which the Piling setting is not applied coincide with each other, for example, as depicted in FIG. 25.

Referring back to FIG. 23, if the version of the own node and the version of each node coupled to a port to which the Piling setting is not applied do not coincide with each other (S51: No), then the second decision unit 52 updates the transmission frame table in the management data storage unit 54. In particular, the second decision unit 52 sets the value of the Comp field to “False” with regard to each of the ports 10p to 40p (S53). Then, the processing is ended.

On the other hand, if the version of the own node and the version of each node coupled to a port to which the Piling setting is not applied coincide with each other (S51: Yes), then the second decision unit 52 updates the transmission frame table in the management data storage unit 54. In particular, the second decision unit 52 sets the value of the Comp field to “True” with regard to each of the ports 10p to 40p (S55).

Depending on whether or not information representing that the Piling setting is applied is stored in the piling table, the second decision unit 52 decides whether or not the own node has a port to which the Piling setting is applied (S57).

If the own node does not include a port to which the Piling setting is applied (S57: No), then the processing is ended. On the other hand, if the own node has a node to which the Piling setting is applied (S57: Yes), then the second decision unit 52 executes the following process. In particular, the second decision unit 52 decides whether or not a CCM frame in which the value of the Comp field is “True” is received from any node coupled to one of the ports to which the Piling setting is not applied (S59).

If a CCM frame in which the value of the Comp field is “True” is not received from any node coupled to one of the ports to which the Piling setting is not applied (S59: No), then the processing is ended. If a CCM frame in which the value of the Comp field is “True” is received from any node coupled to one of the ports to which the Piling setting is not applied (S59: Yes), then the second decision unit 52 generates a completion notification and outputs the generated completion notification to the control circuit interface unit 56. The completion notification includes the identifier of the own node and information representing that the updating is completed.

Then, the control circuit interface unit 56 transmits the completion notification received from the second decision unit 52 to the monitoring controlling apparatus 100 (S61). Then, the processing is ended.

If such processes as described above are executed, then only a node including a port to which the Piling setting is applied (namely, an edge node) transmits the completion notification to the monitoring controlling apparatus 100.

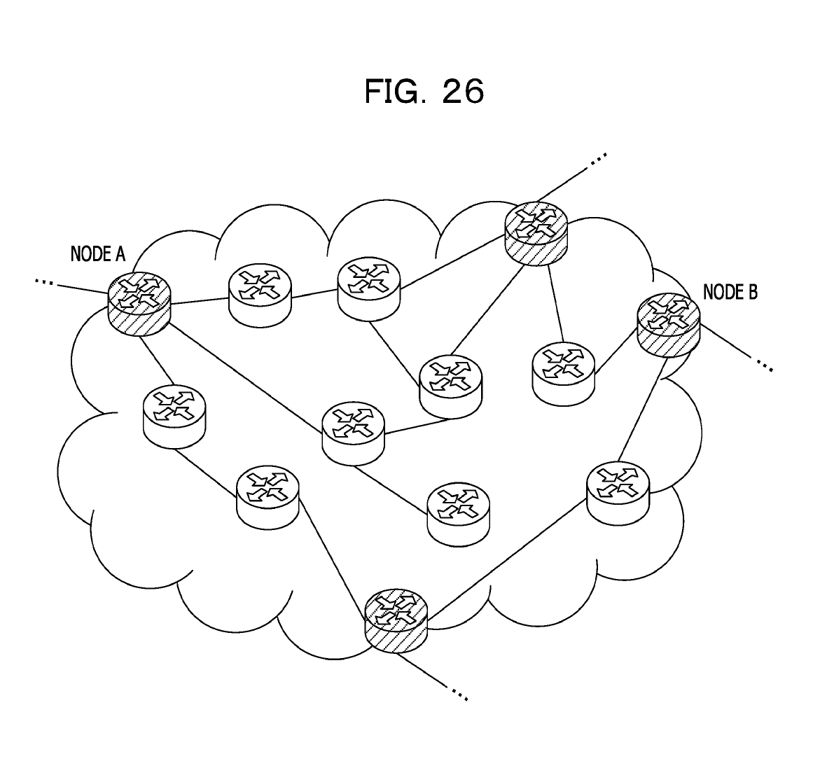

FIG. 26 is a view illustrating a reason why completion of updating can be decided from a completion notification from an edge node. For example, it is assumed that such a network as depicted in FIG. 26 is available and each node to which slanting lines are applied is an edge node. A plurality of routes are available from a node A as a start point to a node B as an end point, and the different routes include different numbers of nodes from each other thereon. However, if the node B receives a CCM frame in which the value of the Comp field is “True” from the ports other than the port to which the Piling setting is applied, then it is considered that this indicates that updating is completed in all nodes on the routes. Therefore, if a completion notification is received from the edge nodes in the network, then the network manager who operates the monitoring controlling apparatus 100 can decide that updating is completed in all nodes in the network.

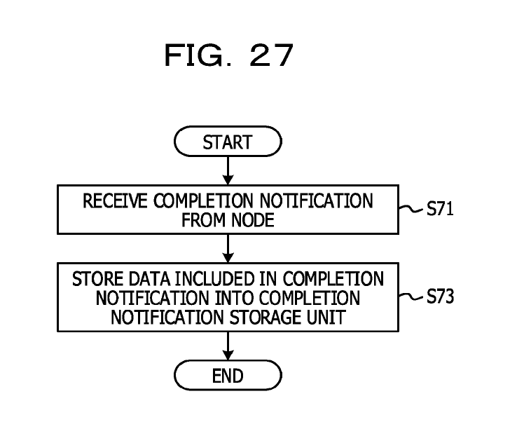

Now, operation of a monitoring controlling apparatus is described with reference to FIGS. 27 to 29. The monitoring controlling apparatus described with reference to FIGS. 27 to 29 may be the monitoring controlling apparatus 100 depicted in FIG. 4.

First, a process executed by the monitoring controlling apparatus 100 when a completion notification is received is described with reference to FIG. 27. The control circuit interface unit 103 of the monitoring controlling apparatus 100 receives a completion notification from a node through a control circuit (FIG. 27: S71). The control circuit interface unit 103 outputs the received completion notification to the management unit 101.

The management unit 101 stores the completion notification received from the control circuit interface unit 103 into the completion notification storage unit 104 (S73). Then, the processing is ended.

Such processing as described above makes it possible to utilize a completion notification received from each edge node in a network of an updating target in later processing.

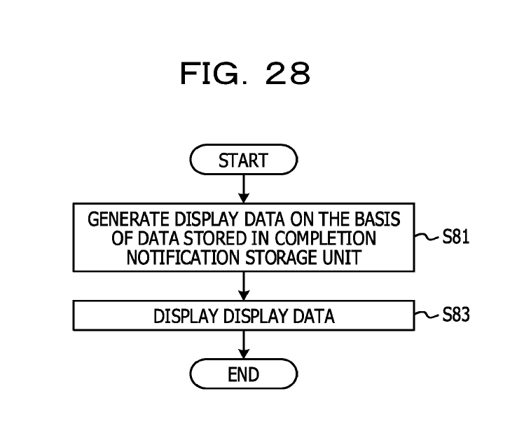

Now, a process for making it possible for the network manager to confirm a progress of updating is described with reference to FIG. 28. The present process is executed, for example, after every fixed interval of time.

The management unit 101 of the monitoring controlling apparatus 100 reads out a completion notification stored in the completion notification storage unit 104 and generates display data on the basis of the read out completion notification (FIG. 28: S81). It is to be noted that, also where a completion notification is not stored in the completion notification storage unit 104, display data indicating that updating is not completed in any edge node is generated.

The management unit 101 outputs the generated display data to the operator interface unit 102. The operator interface unit 102 displays the display data received from the management unit 101 on a display apparatus (S83). Then, the processing is ended.

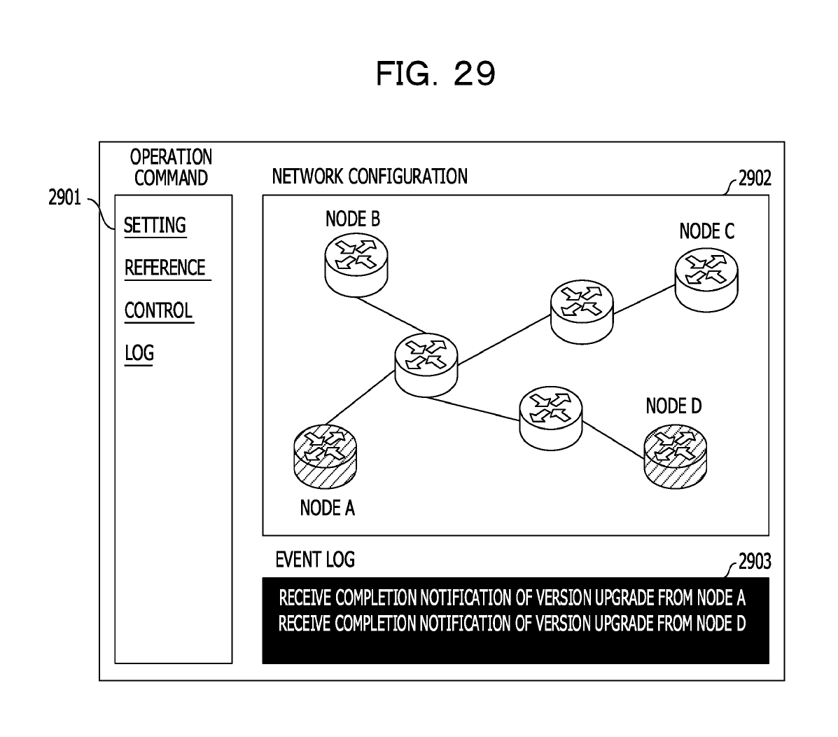

FIG. 29 depicts an example of a display screen image of the display apparatus. In the example of FIG. 29, the display screen image includes a region 2901 in which a list of operation commands for accepting an operation from the network manager is displayed, another region 2902 in which a configuration of a network of an updating target is displayed and a further region 2903 in which an event log is displayed. In the example of FIG. 29, it is displayed that an event that a completion notification is received from nodes A and D has occurred, and slanting lines are applied to icons of the nodes A and D. At the stage at which the network manager confirms that a completion notification is received from each of the edge nodes A and D, the network manager recognizes that updating is completed in the target network. In other words, the network manager need no more confirm completion of updating of the nodes in the network for one by one node.

While a present embodiment has been described, the present embodiment is not limited to the specific embodiment. For example, the functional block configuration of the nodes and the monitoring controlling apparatus 100 described hereinabove does not sometimes coincide with an actual program module configuration.

Further, the configurations of the tables described hereinabove are mere examples and may not be limited particularly. Also in the processing flows, the order of processes may be exchanged if a same processing result is obtained. In addition, some processes may be executed in parallel.

Further, a plurality of networks may be determined as a target of updating depending upon settings in advance by the network manager. In this case, the Piling setting is not applied to ports of edge nodes provided between the networks of the updating target.

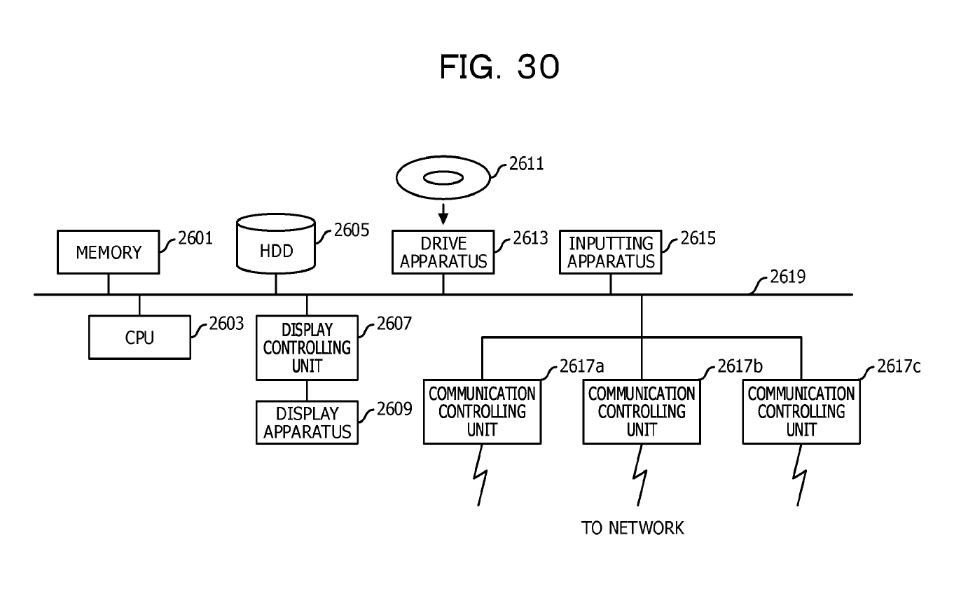

FIG. 30 is a functional block diagram of a node. It is to be noted that any of the nodes described above is sometimes configured in such a manner as depicted in FIG. 30 in which a memory 2601, a CPU 2603, a hard disk drive (HDD) 2605, a display controlling unit 2607 coupled to a display apparatus 2609, a drive apparatus 2613 for a removable disk 2611, an inputting apparatus 2615, and a communication controlling unit 2617 for coupling to a network (in FIG. 30, communication controlling units 2617a to 2617c) are coupled to one another by a bus 2619. It is to be noted that, in some cases, the node does not include the display controlling unit 2607, display apparatus 2609, drive apparatus 2613 and inputting apparatus 2615. An operating system (OS) and a program for performing the processes in the present embodiment are stored in the HDD 2605 and are read out from the HDD 2605 into the memory 2601 when they are to be executed by the CPU 2603. As occasion demands, the CPU 2603 controls the display controlling unit 2607, communication controlling unit 2617 and drive apparatus 2613 to perform demanded operation. It is to be noted that data inputted from any of the communication controlling units 2617a to 2617c is outputted through a different one of the communication controlling units 2617. The CPU 2603 controls the communication controlling unit 2617 to change over an outputting destination appropriately. Further, data being processed are stored into the memory 2601 and are stored into the HDD 2605 as needed. In an embodiment of the present technology, the program for performing the processes described above is stored into and distributed together with the computer-readable removable disk 2611 and then is installed from the drive apparatus 2613 into the HDD 2605. The program may otherwise be installed into the HDD 2605 through a network such as the Internet and the communication controlling unit 2617. In such a computer apparatus as described above, the hardware of the CPU 2603, memory 2601 and so forth described above and the OS and useful programs organically cooperate with each other to implement such various functions as described above.

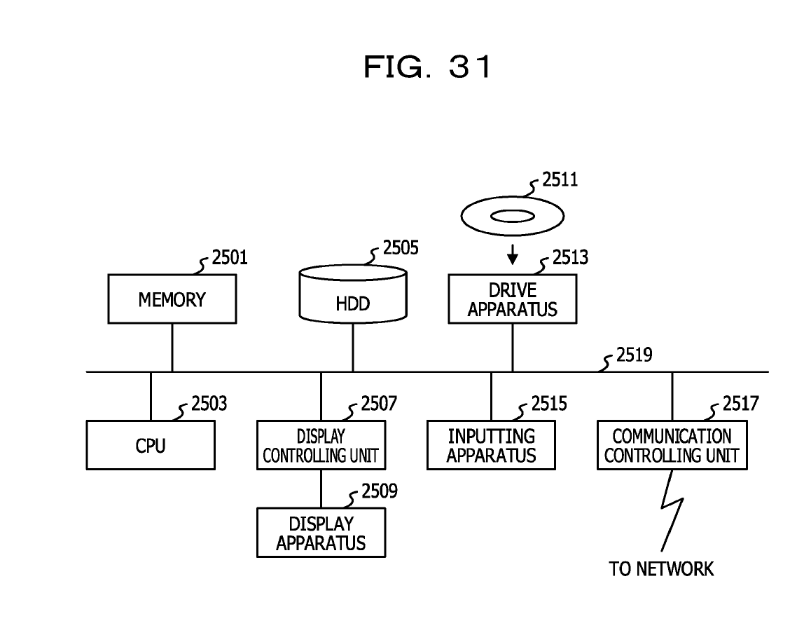

It is to be noted that the monitoring controlling apparatus 100 described hereinabove is a computer apparatus. FIG. 31 is a functional block diagram of a computer. In the computer apparatus, as depicted in FIG. 31, a memory 2501, a CPU 2503, an HDD 2505, a display controlling unit 2507 coupled to a display apparatus 2509, a drive apparatus 2513 for a removable disk 2511, an inputting apparatus 2515 and a communication controlling unit 2517 for coupling to a network are coupled to one another by a bus 2519. An OS and application programs for performing the processes in the present embodiment are stored in the HDD 2505 and are read out from the HDD 2505 into the memory 2501 when they are to be executed by the CPU 2503. The CPU 2503 controls the display controlling unit 2507, communication controlling unit 2517 and drive apparatus 2513 in accordance with processing contents of the application program to perform given operation. Further, although data during processing are stored principally into the memory 2501, it may otherwise be stored into the HDD 2505. In the present embodiment, the application program for performing the processes described hereinabove is stored into and distributed together with the computer-readable removable disk 2511 and then is installed from the drive apparatus 2513 into the HDD 2505. The application program may otherwise be installed into the HDD 2505 through a network such as the Internet and the communication controlling unit 2517. Such a computer apparatus as described above implements such various functions as described above through organic cooperation of the hardware such as the CPU 2503 and the memory 2501 as described above and the OS and programs such as the application program.

The present embodiment described above can be summarized in the following manner.

A transmission apparatus according to a first mode of the present embodiment includes (A) a plurality of ports individually communicatable with different transmission apparatus, (B) a data storage unit configured to store a data file and attribute information of the data file and store, for each of the plurality of ports, management information representative of whether or not a transfer request for the data file is to be met, (C) a first processing unit configured to transmit the attribute information stored in the data storage unit from each of the plurality of ports, and (D) a second processing unit configured to decide, when the transfer request is received from a first one of the plurality of ports, whether or not the data file is to be transmitted from the first port on the basis of the management information stored in the data storage unit.

With the transmission apparatus described above, since the transmission apparatus that are to receive the data file can be limited, the transmission apparatus to be updated can be limited.

The first processing unit described above may (c1) transmit, when it is decided that the data file is to be transmitted from the first port, the data file read out from the data storage unit from the first port, and (c2) transmit, when it is decided that the data file is not to be transmitted from the first port, data representative of rejection of the transfer request from the first port.

Further, (d1) the second processing unit described above may decide, when attribute information is received from a second one of the plurality of ports, whether or not updating in which a data file owned by a different transmission apparatus coupled to the second port is used is to be executed on the basis of the received attribute information and the attribute information stored in the data storage unit, and (c3) the first processing unit may transmit, when it is decided that updating in which the data file owned by the different transmission apparatus coupled to the second port is used is to be executed, the transfer request from the second port. This makes it possible to automatically perform updating to be executed.

Further, the transmission apparatus may further include (E) an updating unit configured to update software or a programmable device of the transmission apparatus with the data file stored in the data storage unit. Further, the first processing unit described above may (c4) transmit, when the updating by the updating unit is completed, information representative of the attribute information after the updating and the completion of the updating from each of the plurality of ports. This makes it possible for the other transmission apparatus to recognize the completion of the updating in the transmission apparatus.

Further, the transmission apparatus may further include (F) a decision unit configured to decide whether or not a condition that information representative of completion of updating is received from each of the ports from which the data file stored in the data storage unit is transmitted is satisfied, and (G) a second communication unit configured to transmit, when it is decided by the decision unit that the condition is satisfied, information representative of completion of the updating to a management apparatus. With the configuration described, since information representative of completion of updating is received only from part of the transmission apparatus, the burden on an operator of the management apparatus can be reduced.

Further, the second processing unit described above may (d2) receive, from the transmission apparatus coupled to the second port, a data file owned by the transmission apparatus.

Further, the second processing unit described above may (d3) receive the data file from the management apparatus.

An updating controlling method for a transmission apparatus according to a second mode of the present embodiment includes (H) storing a data file and attribute information of the data file and transmitting, from each of a plurality of ports of the transmission apparatus through each of which the transmission apparatus is communicatable individually with a different transmission apparatus, attribute information stored in a data storage unit of the transmission apparatus, in which management information indicative of whether or not a transfer request for the data file is to be met is stored for each of the plurality of ports, and (I) deciding, when a transfer request is received from a first one of the plurality of ports, whether or not the data file is to be transmitted from the first port on the basis of the management information stored in the data storage unit.

It is to be noted that a program for causing the processes according to the method described above to be performed by a processor can be created, and the program is stored into a computer-readable storage medium such as, for example, a flexible disk, a compact disc read-only memory (CD-ROM), a magneto-optical disk, a semiconductor memory or a hard disk or into a storage apparatus. It is to be noted that intermediate processing results are temporarily stored into a storage apparatus such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmission apparatus comprising:
a plurality of ports configured to communicate with another transmission apparatus;
a storage configured to store a data file, attribute information of the data file, and management information indicating to respond or not to a transfer request for the data file with respect to each of the plurality of ports, respectively; and
a processor configured to
transmit the attribute information from each of the plurality of ports, and
decide whether or not to transmit the data file from a first port of the plurality of ports on the basis of the management information when the first port receives the transfer request from the other transmission apparatus.

2. The transmission apparatus according to claim 1, wherein the processor
transmits, when it is decided that the data file is to be transmitted from the first port, the data file in the storage from the first port, and
transmits, when it is decided that the data file is not to be transmitted from the first port, data representative of rejection of the transfer request from the first port.

3. The transmission apparatus according to claim 1, wherein the processor
decides, when attribute information is received from a second port of the plurality of ports, whether updating in which a data file owned by a different transmission apparatus coupled to the second port is used is to be executed on the basis of the received attribute information and the attribute information in the storage, and
transmits, when it is decided that updating in which the data file owned by the different transmission apparatus is used is to be executed, the transfer request from the second port.

4. The transmission apparatus according to claim 1, wherein the processor
updates software or a programmable device of the transmission apparatus with the data file in the storage, and
transmits, when the updating is completed, information representative of the attribute information after the updating and the completion of the updating from each of the plurality of ports.

5. The transmission apparatus according to claim 1, wherein the processor
decides whether a condition that information representative of completion of updating is received from each of the ports from which the data file in the storage is transmitted is satisfied, and
transmits, when it is decided that the condition is satisfied, information representative of completion of the updating to a management apparatus.

6. The transmission apparatus according to claim 3, wherein the processor
receives, from any of the different transmission apparatus, a data file owned by the different transmission apparatus.

7. The transmission apparatus according to claim 5, wherein the processor
receives the data file from the management apparatus.

8. A transmission method executed by a transmission apparatus including a plurality of ports configured to communicate with another transmission apparatus, a storage configured to store a data file, attribute information of the data file, and management information indicating to respond or not to a transfer request for the data file with respect to each of the plurality of ports, respectively, and a processor, comprising:
transmitting the attribute information from each of the plurality of ports; and
deciding whether or not to transmit the data file from a first port of the plurality of ports on the basis of the management information when the first port receives the transfer request from the other transmission apparatus.
